(19) United States
(12) Patent Application Publication
(10) Pub. No.: US 2014/0264102 A1
(43) Pub. Date: Sep. 18, 2014

(54) REGULATING VALVE OPENING CONTROLLING SYSTEM

(71) Applicant: Azbil Corporation, Tokyo (JP)

(72) Inventor: Tomomi OGATA, Tokyo (JP)

(73) Assignee: AZBIL CORPORATION, Tokyo (JP)

(21) Appl. No.: 14/210,919

(22) Filed: Mar. 14, 2014

(30) Foreign Application Priority Data
Mar. 14, 2013 (JP) 2013-051416

(51) Int. Cl. F16K 31/42

(52) U.S. Cl. CPC F16K 31/42
USPC 251/30.01

(57) ABSTRACT

A regulating valve opening controlling system includes a regulating valve having a valve and an actuator that receives a pneumatic pressure and drives the valve, and a positioner, provided with the regulating valve, which controls the opening of the valve. The system further includes a regulating valve characteristic information storage portion that stores characteristic information of the regulating valve, provided readably in the regulating valve, a regulating valve characteristic information reading portion that reads the characteristic information of the regulating valve, which is stored in the regulating valve characteristic information storage portion, and an information converting/setting portion that converts into specific information, and sets in the positioner, characteristic information of the regulating valve, which has been read in by the regulating valve characteristic information reading portion.

### CROSS REFERENCE TO RELATED APPLICATION

This application claims priority under 35 U.S.C. §119 to Japanese Patent Application No. 2013-051416, filed on Mar. 14, 2013, the entire content of which being hereby incorporated herein by reference.

### FIELD OF TECHNOLOGY

The present invention relates to a regulating valve opening controlling system that is structured from a regulating valve and a positioner that is installed in the regulating valve.

### BACKGROUND

Conventionally, in this type of regulating valve opening controlling system, a positioner is installed in the regulating valve to control the opening of the valve within the regulating valve. In a regulating valve opening controlling system, the regulating valve has a valve and an actuator for driving the valve, where the positioner controls the opening of the valve by applying, to the actuator, a pneumatic pressure that depends on the difference between the actual valve opening and a setting for the opening.

In such a regulating valve opening controlling system, the regulating valve and the positioner are used in combination, but often they are independent devices, rather than being integrated together as a single unit. Within the positioner functions, there are those that require characteristic information, such as the regulating valve specifications, regarding the regulating valve that is used in combination, and in recent years there has been an expansion also in the characteristic information required for a regulating valve, accompanying increased functionality of the positioner functions, such as fault diagnostics.

For example, in the positioner (valve positioner) disclosed in Japanese Unexamined Patent Application Publication No. 2001-142505 (“the JP '505”, issued as Japanese Patent No. 3724289), it is possible to manually input, into the positioner, specification data for the regulating valve that is to be combined therewith (for example, valve capacity, valve spring range, valve hysteresis, and supply voltage to the actuator) as characteristic information of the regulating valve, through a man-machine interface such as a keyboard or buttons.

In this case, the positioner uses the specification data (the characteristic information) for the regulating valve that has been inputted through the man-machine interface to read out, from a database, control parameters corresponding to the specification data, to set them in the valve controlling/calculating portion. For example, values for control parameters used in controlling the opening of the valve, such as the proportional gain, the integrating time, the differentiating time, and the like, are read out from the database and loaded into the valve controlling/calculating portion.

Often the regulating valve and the positioner are purchased from different vendors, so usually at shipping there is no data in the positioner as to the regulating valve with which it is to be combined. Because of this, when shipping the positioner, it is difficult to obtain the characteristic information of the regulating valve and difficult to set up in advance, in the positioner, the parameter values corresponding to that characteristic information. It is for this reason that, in the JP '505, specification data for the regulating valve (characteristic information) is inputted manually into the positioner at the point in time wherein the regulating valve and the positioner are combined.

As described above, in the JP '505, the characteristic information of the regulating valve is inputted into the positioner through a man-machine interface, such as a keyboard, buttons, or the like. For example, a mobile data reader is used to manually input characteristic information of each individual regulating valve. Because of this, the operation for inputting the characteristic information of the regulating valves is complex and extremely time-consuming.

An instrument controlling system, or the like, can also be used to input the characteristic information of the regulating valves into the positioners. However, there is still a problem in that, in many cases, the inputting is time-consuming because often, even when an instrument controlling system is used, it is not possible to perform the setup as a group, because there are various different characteristic information of the regulating valves, and because the characteristic information that is required regarding the regulating valves differs depending on the positioner (the type and model).

Even if there were a database for managing characteristic information of many different regulating valves as a group, still it would not be possible to link the positioners and the regulating valves together in the instrument controlling system, or the like. Consequently, this does not change the fact that there is the work of having to reference, from the instrument information, the characteristic information of the regulating valve that is combined with each individual positioner, and the fact that the operation for inputting this information is time-consuming.

Moreover, it is not just that it is time-consuming, but rather there is the potential for human error as well, because the operations for checking the regulating valve that is to be combined (Arrow (1) shown in FIG. 9)), reading out, from the database, the characteristic information of the regulating valve that has been checked (Arrow (2) shown in FIG. 9), and inputting, into the positioner, the characteristic information that has been read out for the regulating valve (Arrow (3) shown in FIG. 9) are all performed manually.

The present invention was created in order to solve such a problem, and an aspect thereof is to provide a regulating valve opening controlling system able to reduce the amount of labor in the operation for inputting the characteristic information of the regulating valves into the positioners, and also to able to reduce the likelihood of a human error.

### SUMMARY

In order to achieve such an aspect, the present invention is a regulating valve opening controlling system including: a regulating valve having a valve wherein a passage through which a fluid flows is opened and closed and an actuator for receiving a pneumatic pressure and driving the valve; and a positioner, installed in the regulating valve, for controlling the opening of the valve by applying, to the actuator, a pneumatic pressure that depends on a difference between the actual opening of the valve and an opening setting; including: a regulating valve characteristic information storage portion for storing characteristic information of the regulating valve, provided readably in the regulating valve; a regulating valve characteristic information reading portion for reading the characteristic information of the regulating valve, which is stored in the regulating valve characteristic information storage portion; and an information converting/setting portion for converting into specific information, and setting in the positioner, characteristic information of the regulating valve that has been read in by the regulating valve characteristic information reading portion.

Heretofore, regulating valves have not had means for generating information about themselves. Conventionally, an operation is performed wherein the regulating valve that is to be combined with the positioner is checked, and then a document, database, or the like is referenced in relation thereto, and the characteristic information of the regulating valve is inputted manually into the positioner. The type of characteristic information that is required for the regulating valve depends on the positioner, and because the positioner itself is able to detect the parameter that is the hysteresis of the regulating valve, heretofore it is not been envisioned to have the regulating valve have the information. See, for example, Japanese Unexamined Patent Application Publication No. H11-166655 (“the JP '655”, issued as Japanese Patent No. 3511458).

However, because there are not only many different types of regulating valves, but also a variety of customized components are used, there is a great deal of variation in the characteristic information of the regulating valve that must be inputted into the positioner. Moreover, if there is a change in the combination between the regulator and the positioner, due to, for example, a fault or a modification to a manufacturing line, after the plant has started up and operations have commenced, then it becomes necessary to reinput the characteristic information of the regulating valve.

The inventor in the present application focused on efficiency, including the entire lifecycle of such a regulating valve, and contemplated that if it were possible to read out, into the positioner, characteristic information of a regulating valve from that regulating valve itself, then it would reduce the time and effort for inputting the characteristic information of the regulating valve into the positioner, which is efficient from the perspective of the entire lifecycle. Moreover, the ability to reduce human error thereby was also contemplated.

Because of this, in the present invention a regulating valve characteristic information storage portion, for storing characteristic information of the regulating valve so as to be readable is provided in the regulating valve, where this regulating valve characteristic information that is stored in the regulating valve characteristic information storage portion is read out by a regulating valve characteristic information reading portion, and the characteristic information of the regulating valve that has been read out is converted into the required information by an information converting/setting portion and set in the positioner.

Note that, in the present invention, reading of the characteristic information of the regulating valve, which is stored in the regulating valve characteristic information storage portion, is performed by the regulating valve information reading portion, and the conversion of the regulating valve characteristic information that has been read out into the required information, and setting it up in the positioner, is performed by the information converting/setting portion, but the regulating valve characteristic information reading portion and the information converting/setting portion may instead be provided in the positioner, or, conversely, may be provided in a device other than the positioner (such as a mobile data reader, an instrument controlling system, or the like).

Moreover, in the present invention the regulating valve characteristic information reading portion may receive a command for starting reading, sent through a manual operation, to start reading out the regulating valve characteristic information that is stored in the regulating valve characteristic information storage portion. For example, when a positioner is installed in a regulating valve and the operator instructs that reading is to start, then reading of regulating valve characteristic information from the regulating valve characteristic information storage portion that is provided in the regulating valve is started. That is, upon a command from the operator to start reading, the regulating valve characteristic information is read out, the characteristic information that has been read out is converted into the required information, and the converted required information is set up in the positioner, semiautomatically.

Moreover, the present invention may be provided with a regulating valve characteristic information read-enabled checking portion for checking whether or not the characteristic information of the regulating valve, which is stored in the regulating valve characteristic information storage portion can be read; wherein: reading of the characteristic information of the regulating valve, which is stored in the regulating valve characteristic information storage portion may begin upon confirmation, by the regulating valve characteristic information read-enabled checking portion, that the characteristic information can be read. Doing this enables reading of the characteristic information of the regulating valve, conversion, into the required information, of the characteristic information of the regulating valve that has been read in, and setting up the converted required information in the positioner can all be performed fully automatically when the positioner is installed in the regulating valve.

Moreover, in the present invention, characteristic information of the regulating valve may be stored in a memory, and the stored characteristic information of the regulating valve may be read out through a communication line (read out through wired communication), or may be read out through wireless communication. Moreover, the characteristic information of the regulating valve may be stored so as to be readable optically from the outside, and the characteristic information that is stored may be read out optically without contact.

Moreover, in the present invention, the regulating valve characteristic information storage portion may be provided separately from a valve characteristic information storage portion for storing characteristic information of a valve, provided so as to be readable on the valve side, and from an actuator characteristic information storage portion for storing characteristic information of the actuator, stored so as to be readable on the actuator side. The regulating valve is structured from the valve and the actuator. While there are many different combinations of valves and actuators, having a valve characteristic information storage portion on the valve side and an actuator characteristic information storage portion on the actuator side makes it possible to read in the characteristic information of the valve from the valve side and read in the characteristic information of the actuator from the actuator side, thus providing the rich flexibility of being able to acquire the correct characteristic information of a regulating valve that is installed, regardless of the combination of the valve and the actuator, even if, during operations, the combination of the valve and the actuator is changed.

Moreover, in the present invention, the characteristic information of the regulating valve, read in by the regulating valve characteristic information reading portion, is converted into the required information and set up in the positioner. In this case, one may consider parameter values such as control parameters that are used in controlling the opening of the regulating valve, diagnostic parameters used in fault diagnostics in the regulating valve, as described in, for example, Japanese Unexamined Patent Application Publication No. 2004-21437, “the JP '437”, and the like, as the converted required information. But there are also cases wherein characteristic information of the regulating valve that has been read in, such as the opening diameter of the valve, is set up in the positioner as-is as a parameter value. The present invention includes, as “converted required information,” such regulating valve characteristic information that is set as-is, in the positioner.

In the present invention, a regulating valve characteristic information storage portion for storing characteristic information of the regulating valve in the regulating valve so as to be readable is provided, where this regulating valve characteristic information that is stored in the regulating valve characteristic information storage portion is read in by the regulating valve characteristic information reading portion, and the regulating valve characteristic information that has been read in is converted into the required information by the information converting/setting portion, and set up in the positioner, and thus all of the operation for inputting the characteristic information of the regulating valves into the positioner, to reference the regulating valve characteristic information without requiring time or labor (checking the regulating valve manually and read in the regulating valve characteristic information manually), or a portion thereof, may be automated, making it possible to reduce the time and labor in the operation for inputting the characteristic information of the regulating valve into the positioner. Moreover, this can also reduce the possibility of human error, such as referencing the characteristic information of the wrong regulating valve or making an error when inputting the information, omitting information, or the like.

### BRIEF DESCRIPTIONS OF THE DRAWINGS

FIG. 1 is a diagram illustrating the critical portions in an example of a regulating valve controlling system according to the present invention.

FIG. 2 is a diagram illustrating an example (Specific Example 1) wherein characteristic information of a regulating valve is read out from a regulating valve characteristic information storage portion through a communication circuit (through wired communication).

FIG. 3 is a diagram illustrating an example (Specific Example 2) wherein characteristic information of a regulating valve is read out from a regulating valve characteristic information storage portion through wireless communication.

FIG. 4 is a diagram illustrating an example (Specific Example 3) wherein characteristic information of a regulating valve is read out optically from a regulating valve characteristic information storage portion.

FIG. 5 is a diagram illustrating an example wherein a mode checking function is provided in a positioner.

FIG. 6 is a diagram illustrating an example wherein characteristic information of valves and actuators are stored separately.

FIG. 7 is a diagram illustrating an example wherein a regulating valve characteristic information reading portion and an information converting setting portion are provided in a mobile communicator.

FIG. 8 is a diagram illustrating an example wherein a regulating valve characteristic information reading portion and an information converting setting portion are provided in an instrument controlling system.

FIG. 9 is a diagram for explaining an operation for inputting regulating valve characteristic information into a conventional positioner.

### DETAILED DESCRIPTION

The present invention will be explained in detail below based on the drawings.

FIG. 1 is a diagram illustrating the critical portions in an example of a regulating valve controlling system according to the present invention. In this figure, 1 is a regulating valve and 2 is a positioner that is equipped in the regulating valve 1, where the regulating valve controlling system 100 according to the present example is structured from the regulating valve 1 and the positioner 2.

In this regulating valve opening controlling system 100, the regulating valve 1 is provided with a valve 1-1 for opening and closing the passage through which a fluid flows, and an actuator 1-2 for receiving a pneumatic pressure Pout, to drive the valve 1-1. Moreover, the regulating valve 1 is provided with a regulating valve characteristic information storage portion 1-3, as a distinctive structure in the present example, for storing characteristic information of the regulating valve 1.

In the regulating valve 1, characteristic information of the regulating valve 1 is stored readably in the regulating valve characteristic information storage portion 1-3. For example, as characteristic information of the regulating valve 1, the opening diameter of the valve, a valve opening diameter signal, a valve model number, a regulating valve model number, a unique identifier for the regulating valve, and the like is stored readably, as characteristic information of the regulating valve 1, in the regulating valve characteristic information storage portion 1-3. A specific example of a regulating valve characteristic information storage portion 1-3 will be discussed below.

In this regulating valve opening controlling system 100, the positioner 2 is provided with a regulating valve characteristic information reading portion 2-2 and an information converting/setting portion 2-3, as distinctive structures in the present example, in addition to a valve controlling/calculating portion 2-1.

In the positioner 2, when the valve controlling/calculating portion 2-1 inputs an actual opening θpv of the valve 1-1 in the regulating valve 1, and a second opening θsp, from a higher-level device (not shown), to generate, and apply to the actuator 1-2 of the regulating valve 1, a pneumatic pressure Pout that depends on the difference between the actual opening θpv and the setting opening θsp. The opening of the valve 1-1 is controlled so that θpv will equal θsp.

In the positioner 2, a regulating valve characteristic information reading portion 2-2 receives a read start command that is sent from the outside, and starts reading out the characteristic information of the regulating valve 1, which is stored in the regulating valve characteristic information storage portion 1-3. For example, operating buttons are provided on the positioner 2, and when an operating button is pressed by an operator, the read start command is sent to the regulating valve characteristic information reading portion 2-2. Conversely, the read start command may be sent from a higher-level device as an operating command from the operator. When this read start command is received, the regulating valve characteristic information reading portion 2-2 accesses the regulating valve characteristic information storage portion 1-3, and begins reading the characteristic information of the regulating valve 1.

The characteristic information of the regulating valve 1 that has been read in by the regulating valve characteristic information reading portion 2-2 is sent to the information converting/setting portion 2-3. The information converting/setting portion 2-3 converts the characteristic information of the regulating valve 1 that has been sent from the regulating valve characteristic information reading portion 2-2, that is, the characteristic information of the regulating valve 1 that has been read out by the regulating valve characteristic information reading portion 2-2, into parameter values corresponding to the characteristic information, and sets them in a valve controlling/calculating portion 2-1.

In the present example, the information converting/setting portion 2-3 stores various types of parameter information such as, for example, control parameters that are used in controlling the opening of the valve, such as the proportional gain, the integrating time, the differentiating time, and the like. The information converting/setting portion 2-3 reads out parameter values, depending on the characteristic information, from the characteristic information of the regulating valve 1 that have been read out by the regulating valve characteristic information reading portion 2-2, and sets them in the valve controlling/calculating portion 2-1.

Note that in this characteristic information of the regulating valve 1, read in by the regulating valve characteristic information reading portion 2-2, the opening diameter of the valve, etc., are set in the valve controlling/calculating portion 2-1 as-is, as the parameter values of the characteristic information that have been read in. Moreover, if the positioner 2 is provided with a regulating valve fault diagnostics function where information pertaining to fault diagnostics of the regulating valve are included in the characteristic information of the regulating valve 1 that is read in by the regulating valve characteristic information reading portion 2-2, then this information is converted into diagnostic parameters used in the fault diagnostics for the regulating valve, and the converted diagnostic parameter values are set up in a fault diagnostics function portion (not shown). Note that the valve controlling/calculating portion 2-1 is not limited to a fault diagnostics functioning portion (not shown), but, of course, this may be applied also if the target for setting the parameter values is a memory able to store parameters.

In this way, in the regulating valve opening controlling system 100 according to the present example, when a positioner 2 is installed in a regulating valve 1, by merely sending a read start command, through a manual operation, to the regulating valve characteristic information reading portion 2-2 of the positioner 2, the characteristic information of the regulating valve 1 is read in from the regulating valve characteristic information storage portion 1-3, the characteristic information that has been read in is converted into parameter values, and the converted parameter values are set.

As a result, in the regulating valve opening controlling system 100 according to the present example, the time and effort for referencing the characteristic information of the regulating valve 1 (manually checking the regulating valve 1, and manually reading the characteristic information of the regulating valve 1) can be eliminated, automating a portion of the operation for inputting the characteristic information of the regulating valve 1 into the positioner 2, thus making it possible to reduce the time and effort in the operation for inputting the characteristic information of the regulating valve 1. Moreover, this can also reduce the possibility of human error, such as referencing the characteristic information of the wrong regulating valve or making an error when inputting the information, omitting information, or the like.

FIG. 2 illustrates a specific example (Specific Example 1) of a system for reading characteristic information of a regulating valve 1 from the regulating valve characteristic information storage portion 1-3. In the Specific Example 1, the regulating valve characteristic information storage portion 1-3 is a memory, where the characteristic information of the regulating valve 1 is stored in this memory. Furthermore, a communication line is provided between the regulating valve characteristic information storage portion 1-3 of the regulating valve 1 and the regulating valve characteristic information reading portion 2-2 of the positioner 2, where the characteristic information of the regulating valve 1, which is stored in the regulating valve characteristic information storage portion 1-3 (the memory) is read out through this communication line. That is, the characteristic information of the regulating valve 1 is read out through wired communication.

FIG. 3 illustrates another specific example (Specific Example 2) of a system for reading characteristic information of a regulating valve 1 from the regulating valve characteristic information storage portion 1-3. In this Specific Example 2, the regulating valve characteristic information storage portion 1-3 is an RFID (Radio Frequency ID) tag, where the characteristic information of the regulating valve 1 is stored in the RFID tag. Note that an RFID tag is also a type of memory as referenced in the present invention. Given this, an RFID reader is used as the regulating valve characteristic information reading portion 2-2 in the positioner 2, where the characteristic information of the regulating valve 1, which is stored in the regulating valve characteristic information storage portion 1-3 (the RFID tag) is read out through wireless communication between the RFID tag and the RFID reader. That is, the characteristic information of the regulating valve 1 is read out through wireless communication.

FIG. 4 illustrates yet another specific example (Specific Example 3) of a system for reading characteristic information of a regulating valve 1 from the regulating valve characteristic information storage portion 1-3. In this Specific Example 3, a sticker whereon a barcode is printed is used as the regulating valve characteristic information storage portion 1-3, where the characteristic information of the regulating valve 1 is stored as a barcode on the sticker. This sticker is adhered to an outside surface, for example, of the regulating valve 1. Given this, a camera is used as the regulating valve characteristic information reading portion 2-2 of the positioner 2, and an image of the barcode that is printed on the sticker is captured by the camera, to read out, optically, without contact, the characteristic information of the regulating valve 1, which is stored in the regulating valve characteristic information storage portion 1-3 (the sticker).

Note that while in the Specific Example 3, illustrated in FIG. 4, a barcode was used to enable the characteristic information of the regulating valve 1 to be read out optically from the outside, there is no limitation to a barcode, of course. For example, a QR code™ may be used instead of a barcode.

Moreover, while in the example set forth above, the structure may be one wherein a read start command was sent through a manual operation to the regulating valve characteristic information reading portion 2-2 of the positioner 2, when, for example, the positioner 2 is installed in the regulating valve 1, the regulating valve characteristic information storage portion 1-3 of the regulating valve 1 may go into a read-out mode for a specific time interval, that is, a mode wherein the characteristic information of the regulating valve 1, which is stored, can be read out, where the positioner 2 checks whether or not this mode wherein reading is possible has been entered, to start the operation of the regulating valve characteristic information reading portion 2-2. In this case, the regulating valve characteristic information storage portion 1-3 of the regulating valve 1 goes into a sleep mode after a specific amount of time has elapsed.

FIG. 5 shows an example of the provision of a mode checking function in the positioner 2. In this example, if a positioner 2 is installed, the regulating valve 1 has a function wherein it goes into a mode wherein the regulating valve 1 regulating valve characteristic information storage portion 1-3 can be read over a specific time interval, and then after that specific time interval has elapsed, goes into a sleep mode. Assuming that the installation is into a regulating valve 1 that has such a function, the positioner 2, in the example illustrated in FIG. 5, is provided with a mode checking portion 2-4 for checking whether or not the regulating valve characteristic information storage portion 1-3 of the regulating valve 1 is in a mode wherein reading is enabled.

When, in the positioner 2, the mode checking portion 2-4 confirms that the regulating valve characteristic information storage portion 1-3 of the regulating valve 1 is in the reading-enabled mode, it sends a read start command to the regulating valve characteristic information reading portion 2-2. Upon receipt of this read start command, the regulating valve characteristic information reading portion 2-2 accesses the regulating valve characteristic information storage portion 1-3, to start reading out the characteristic information of the regulating valve 1, which is stored in the regulating valve characteristic information storage portion 1-3. As a result, when the positioner 2 is installed in the regulating valve 1, in the positioner 2 the characteristic information is read out from the regulating valve 1, the characteristic information that has been read out is converted into parameter values, and the converted parameter values are set, all fully automatically.

Moreover, while in the example set forth above the characteristic information of the regulating valve 1 was stored in a single regulating valve characteristic information storage portion 1-3, instead the characteristic information may be stored separately for the valve 1-1 and the actuator 1-2. FIG. 6 shows one example of this.

In the example illustrated in FIG. 6, a valve characteristic information storage portion 1-31 for storing characteristic information of the valve 1-1 is provided on the valve 1-1 side, and an actuator characteristic information storage portion 1-32, for storing the characteristic information of the actuator 1-2, is provided on the actuator 1-2 side.

In this case, when the regulating valve characteristic information reading portion 2-2 of the positioner 2 receives a read start command, the characteristic information of the valve 1-1 is read out from the valve characteristic information storage portion 1-31 and the characteristic information of the actuator 1-2 is read out from the actuator characteristic information storage portion 1-32, and the characteristic information that has been read out for the valve 1-1 and the actuator 1-2 is combined and sent to the information converting/setting portion 2-3 as the characteristic information of the regulating valve 1.

While, in the regulating valve 1, there can be many different combinations of valves 1-1 and actuators 1-2, storing respectively in the valve characteristic information storage portion 1-31 on the valve 1-1 side and in the actuator characteristic information storage portion 1-32 on the actuator 1-2 side, enables the characteristic information of the valve 1-1 to be read in from the valve 1-1 side and the characteristic information of the actuator 1-2 to be read in from the actuator 1-2 side, so that regardless of the combination of the valve 1-1 and the actuator 1-2, and even if the combination of the valve 1-1 and the actuator 1-2 were to be changed, it is still possible to obtain the correct characteristic information of the regulating valve 1 but is installed, providing rich flexibility.

Moreover, while, in the example set forth above, the regulating valve characteristic information reading portion 2-2 and the information converting/setting portion 2-3 were provided in the positioner 2 as structures that are distinctive to the present example, these structures may be provided in a device other than the positioner 2

For example, a regulating valve characteristic information reading portion 3-1 and an information converting/setting portion 3-2, corresponding to the regulating valve characteristic information reading portion 2-2 and the information converting/setting portion 2-3, may be provided in a mobile data reader 3, as illustrated in FIG. 7, and the mobile data reader 3 may be connected between the regulating valve 1 and the positioner 2.

Moreover, as illustrated in FIG. 8, a regulating valve characteristic information reading portion 4-1 and an information converting/setting portion 4-2, structured corresponding to the regulating valve characteristic information reading portion 2-2 and the information converting/setting portion 2-3, may be provided in an instrument controlling system 4, and this instrument controlling system 4 may be connected between the regulating valve 1 and the positioner 2.

In this case, the reading of characteristic information of the regulating valve 1 by the mobile data reader 3 or the instrument controlling system 4 may be through a system such as serial signals, wireless signals, a two-dimensional image (a barcode or QR code), or the like. Moreover, the transmission of parameter values from the mobile data reader 3 or the instrument controlling system 4 to the positioner 2 may be through a serial signal, a Fieldbus signal, an Ethernet™ signal, or the like.

Note that, in FIG. 7, the regulating valve characteristic information reading portion 3-1 may be separated from the mobile data reader 3, or provided as an independent device, or the like. Moreover, the system may be such that the mobile data reader 3 is connected between the regulating valve 1 and the positioner 2 only when in use, or may be such that it is always connected. It may also be as in the system illustrated in FIG. 8.

### EXTENDED EXAMPLES

While the present invention has been explained above in reference to the example, the present invention is not limited to the example set forth above. The structures and details in the present invention may be varied in a variety of ways, as can be understood by one skilled in the art, within the scope of technology in the present invention.

1. A regulating valve opening controlling system comprising:
a regulating valve having a valve wherein a passage through which a fluid flows is opened and closed and an actuator that receives a pneumatic pressure and drives the valve;
a positioner, provided with the regulating valve, which controls the opening of the valve by applying, to the actuator, a pneumatic pressure that depends on a difference between the actual opening of the valve and an opening setting;
a regulating valve characteristic information storage portion that stores characteristic information of the regulating valve, provided readably in the regulating valve;
a regulating valve characteristic information reading portion that reads the characteristic information of the regulating valve, which is stored in the regulating valve characteristic information storage portion; and
an information converting/setting portion that converts into specific information, and sets in the positioner, characteristic information of the regulating valve, which has been read in by the regulating valve characteristic information reading portion.

2. The regulating valve opening controlling system as set forth in claim 1, wherein:
the regulating valve characteristic information reading portion and information converting/setting portion are provided in the positioner.

3. The regulating valve opening controlling system as set forth in claim 1, wherein:
the regulating valve characteristic information reading portion and information converting/setting portion are provided in a device other than the positioner.

4. The regulating valve opening controlling system as set forth in claim 1, wherein:
the regulating valve characteristic information reading portion receives a read start command that is sent through a manual operation, to start reading the characteristic information of the regulating valve, which is stored in the regulating valve characteristic information storage portion.

5. The regulating valve opening controlling system as set forth in claim 1, comprising:
a regulating valve characteristic information read-enabled checking portion that checks whether or not the characteristic information of the regulating valve, which is stored in the regulating valve characteristic information storage portion, is readable; wherein:
the regulating valve characteristic information reading portion begins reading the characteristic information of the regulating valve, which is stored in the regulating valve characteristic information storage portion upon confirmation, by the regulating valve characteristic information read-enabled checking portion, that the characteristic information is readable.

6. The regulating valve opening controlling system as set forth in claim 1, wherein:
the regulating valve characteristic information storage portion stores the regulating valve characteristic information in a memory; and
the regulating valve characteristic information reading portion reads out the characteristic information of the regulating valve through a communication line that is connected between the regulating valve characteristic information storage portion and the regulating valve characteristic information reading portion.

7. The regulating valve opening controlling system as set forth in claim 1, wherein:
the regulating valve characteristic information storage portion stores the regulating valve characteristic information in a memory; and
the regulating valve characteristic information reading portion reads out the characteristic information of the regulating valve through wireless communication between the regulating valve characteristic information storage portion and the regulating valve characteristic information reading portion.

8. The regulating valve opening controlling system as set forth in claim 1, wherein:
the regulating valve characteristic information storage portion stores the characteristic information of the regulating valve so as to be optically readable from the outside; and
the regulating valve characteristic information reading portion reads the characteristic information of the regulating valve optically, without contact.

9. The regulating valve opening controlling system as set forth in claim 1, wherein:
the regulating valve characteristic information storage portion comprises:
a valve characteristic information storage portion that is equipped readably on the valve side, and stores characteristic information of the valve; and
an actuator characteristic information storage portion that is equipped readably on the actuator side, and stores characteristic information of the actuator.

10. The regulating valve opening controlling system as set forth in claim 1, wherein:
the information converting/setting portion converts into a control parameter that is used in controlling the opening of the regulating valve, or into a diagnostics parameter that is used in fault diagnostics of the regulating valve, and sets up in the positioner, the characteristic information of the regulating valve, read in by the regulating valve characteristic information reading portion.
